(19) United States
(12) Patent Application Publication
(10) Pub. No.: US 2017/0031609 A1
(43) Pub. Date: Feb. 2, 2017

(54) INFORMATION PROCESSING DEVICE, RECORDING MEDIUM AND ACCESS INFORMATION MANAGEMENT METHOD

(71) Applicant: FUJITSU LIMITED, Kawasaki-shi (JP)

(72) Inventor: Naoto Fukumoto, Kawasaki (JP)

(73) Assignee: FUJITSU LIMITED, Kawasaki-shi (JP)

(21) Appl. No.: 15/168,686

(22) Filed: May 31, 2016

(30) Foreign Application Priority Data
Jul. 31, 2015 (JP) 2015-152119

(51) Int. Cl. G06F 3/06; G06F 12/02

(52) U.S. Cl. CPC G06F 3/0613; G06F 3/0653; G06F 3/0673; G06F 12/023; G06F 2212/251

(57) ABSTRACT

An information processing device includes a processor. The processor obtains, for every prescribed number of accesses to the memory, access history information representing a history of an access to a memory and information of an access time taken to obtain information from the memory through the access, and performs an interpolation process on access history information for the prescribed number of accesses on the basis of the access history information corresponding to the access time when the access time is shorter than a threshold.

### CROSS-REFERENCE TO RELATED APPLICATION

This application is based upon and claims the benefit of priority of the prior Japanese Patent Application No. 2015-152119, filed on Jul. 31, 2015, the entire contents of which are incorporated herein by reference.

### FIELD

The embodiments discussed herein are related to an information processing device, a recording medium and an access information management method.

### BACKGROUND

A central processing unit (CPU) accesses a memory device (referred to as a memory hereinafter) so as to obtain data in accordance with the execution of a program. In the above process, information of the access to the memory is accumulated as memory access history information. Memory access history information thus accumulated is once held by a memory and is written to a disk device (referred to as a disk hereinafter). Memory access history information can be used for code tuning, debugging, simulation of memory layers, determination of allocation of data to a high-performance memory, etc.
Patent Document 1: Japanese Laid-open Patent Publication No. 10-254739
Patent Document 2: Japanese Laid-open Patent Publication No. 11-272518
Patent Document 3: International Publication Pamphlet No. 2006-524375
Patent Document 4: Japanese Laid-open Patent Publication No. 07-191882
Patent Document 5: Japanese Laid-open Patent Publication No. 2013-117800

### SUMMARY

According to an aspect of the embodiment, an information processing device includes a processor. The processor obtains, for every prescribed number of accesses to the memory, access history information representing a history of an access to a memory and information of an access time taken to obtain information from the memory through the access and performs an interpolation process on access history information for the prescribed number of accesses on the basis of the access history information corresponding to the access time when the access time is shorter than a threshold.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 explains a memory access time;

FIG. 2A illustrates relationships between times of day of memory accesses and the accessed data addresses regarding intermittent collection of pieces of memory access history information;

FIG. 2B illustrates interpolation of pieces of memory access history information in accordance with the memory access time, the memory access history information having been intermittently collected;

FIG. 3 illustrates an example of an information processing device according to the present embodiment;

FIG. 4 illustrates an example of a memory access history information output device according to the present embodiment;

FIG. 5 exemplifies memory access history relationship information according to the present embodiment;

FIG. 6 illustrates an example of an output of interpolated memory access history information according to the present embodiment;

FIG. 7 illustrates an interpolation process flow for memory access history information in the present embodiment (example 1);

FIG. 8 illustrates an interpolation process flow of memory access history information in the present embodiment (example 2);

FIG. 9 illustrates another output example (variation example 1) of interpolated memory access history information according to the present embodiment;

FIG. 10 illustrates an interpolation process flow of memory access history information according to the present embodiment (variation example 1);

FIG. 11 illustrates another output example (variation example 2) of interpolated memory access history information according to the present embodiment;

FIG. 12 illustrates an interpolation process flow of memory access history information in the present embodiment (variation example 2); and

FIG. 13 illustrates an example of a configuration block of a hardware environment of a computer that executes a program according to the present embodiment.

### DESCRIPTION OF EMBODIMENTS

Writing information to a memory or a disk takes along time against an execution time of one instruction. For example, obtaining all pieces of memory access history information from a memory and writing them to a disk takes a period of time from 1000 times to 10000 times an execution time of an ordinary application program. This leads to a situation where obtaining of memory access history information of a program that can be executed in about ten seconds takes one day or longer.

In view of this, it may be possible to narrow down the amount of memory access history information to be obtained. The first method of reducing the amount of obtained memory access history information may be of collecting pieces of memory access history information only during an important portion of a period.

Using the first method realizes high accuracy in collecting pieces of memory access history information in an important period. However, the first method requires that pieces of information in an important period be distinguished from other pieces of memory access history information. This requires vast knowledge of the application program, leading to complicated setting of that application program. Also, when an important period is long, a time taken for collecting pieces of memory access history information remains long.

In view of this, it may be possible to collect pieces of memory access history information for every prescribed number of memory accesses instead of collecting all pieces of the memory access history information, as the second method of reducing the amount of memory access history information to be obtained.

Using the second method makes it possible to collect pieces of memory access history information in a short period of time and without paying much effort. However, longer intervals of collecting pieces of memory access history information will lower the accuracy of the memory access history information.

As described above, when pieces of memory access history information are collected for every prescribed number of memory accesses, the accuracy of the memory access history information lowers in accordance with the interval of collecting pieces of the memory access history information.

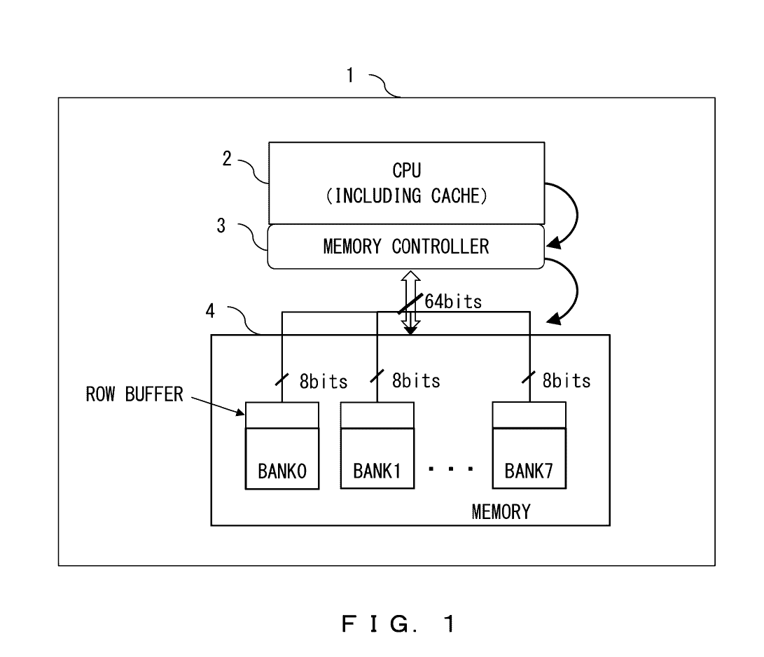

By referring to the drawings, the embodiments will be explained. FIG. 1 explains a memory access time. An information processing device 1 includes a CPU 2, a memory controller 3 and a memory 4. The CPU 2 includes a high-speed small-capacity memory for shortening the performance difference between the processing device and the storage device.

The memory controller 3 controls the memory device for reading of data from the memory 4, writing of data to the memory 4 and refreshing of the memory 4, etc.

The memory 4 is adopted the memory interleave technology, in which a memory is divided into a plurality of banks in units of accesses, continuous addresses are assigned across the plurality of banks, and accesses are made in parallel to the respective banks so as to increase the efficiency in accessing the memory. An example of the memory 4 is a dual inline memory module (DIMM) having a plurality of DRAM chips mounted on a substrate. Information held by each bank is read through Row buffer.

First, the CPU 2 transmits a data request to the memory controller 3. The memory controller 3 rearranges pieces of requested data in order to increase the hit rate of Row buffer, and transmits it to the memory 4.

When Row buffer has requested data, the memory 4 provides that data to the CPU 2 as it is. This shortens the time (memory access time) between when an access request is made for the memory and when the response to it is made.

When the Row buffer does not have requested data, the memory 4 reads the requested data from a corresponding DRAM chip, writes it to the Row buffer, and thereafter provides it to the CPU 2. Accordingly, the memory access time becomes longer than in a case where there is a hit for the data in the Row buffer.

As described above, latency of a memory access time varies depending upon hits or misses of data in the Row buffer.

In the case of memory accesses to continuous addresses (continuous accesses, i.e., sequential access), it is highly likely that the Row buffer of each bank holds data of the continuous addresses. This increases the hit rate of data in the Row buffer in the case of memory accesses to continuous addresses (continuous accesses), shortening a time taken to access the main memory.

Accordingly, the present embodiment considers a memory access of a short access time to be occurring during continuous accesses. Also, a memory access previous to an address collected in a short access time is treated as continuous accesses, and is added to the collected data (a period that is treated as a period of continuous accesses is changed in accordance with the length of the access time).

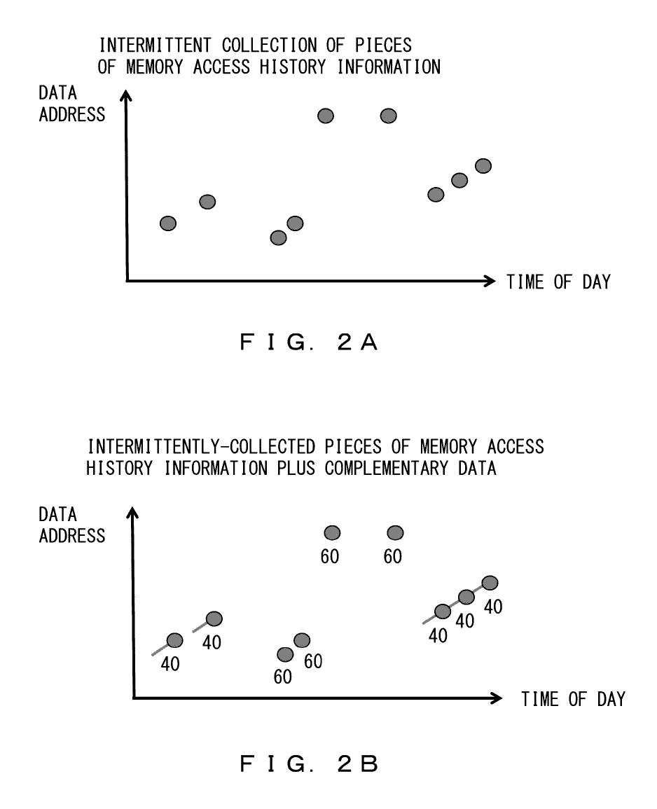

FIG. 2A illustrates relationships between times of day of memory accesses and the accessed data addresses regarding intermittent collection of pieces of memory access history information. The dots in FIG. 2A represent the data addresses accessed at the corresponding times of day. As illustrated in FIG. 2A, pieces of information of memory access history information etc. for every prescribed number of memory accesses are collected instead of collecting all pieces of the memory access history information. Information to be collected includes the memory access history information obtained in response to the memory access made at the corresponding timing and the period of time between when the access request was made and when the CPU obtained the data provided from the memory in response to that access request (memory access time of the data).

FIG. 2B illustrates the interpolation of pieces of memory access history information in accordance with the memory access time, the memory access history information having been intermittently collected in FIG. 2A. The values represented by the dots in FIG. 2B represent the average memory access times for the memory accesses corresponding to the dots.

It is assumed for example that 40 ns<threshold [nano seconds]<60 ns. When the threshold average memory access time is 40 ns, 40 ns is smaller than the threshold, the average memory access time is determined to be short. In such a case, the memory access is determined to be continuous accesses, i.e., a sequential access. Then, as depicted by the segments drawn from the dots in FIG. 2B, the intermitted portions in the memory access history information are interpolated. Specifically, n pieces of memory access history information for the past intermitted portions that are estimated to have inherently been at the corresponding positions are added to the position immediately previous to the memory access history information.

Also, when the threshold average memory access time is 60 ns, 60 ns is greater than the threshold, the average memory access time is determined to be long. In such a case, the memory access is determined to be not continuous accesses, i.e., to be not a sequential access, and the memory access history information is not interpolated.

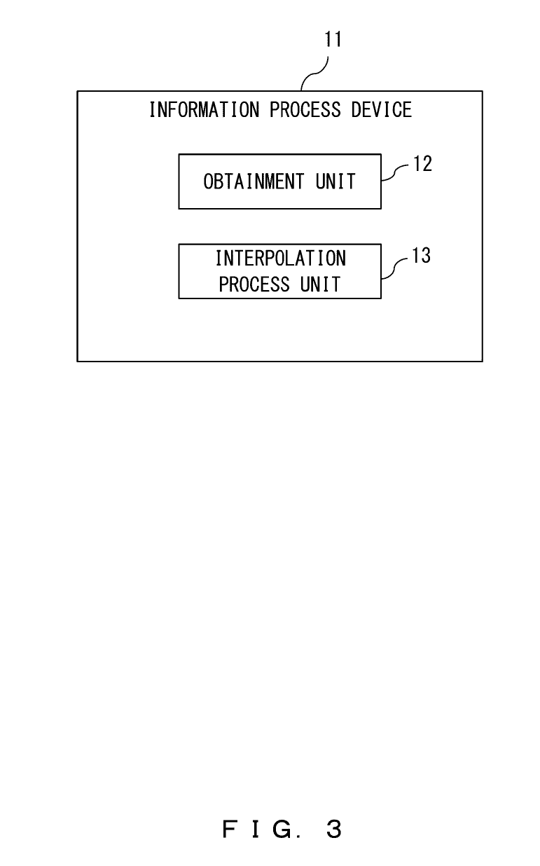

FIG. 3 illustrates an example of an information processing device according to the present embodiment. An information process device 11 includes an obtainment unit 12 and an interpolation process unit 13.

The obtainment unit 12 obtains access history information that represents the history of accesses to the memory and information on the access times taken for the accesses made to obtain pieces of information from the memory for every prescribed number of accesses to the memory. An example of the obtainment unit 12 is a collection unit 2, which will be explained later.

When the access time is shorter than the threshold, the interpolation process unit 13 performs an interpolation process on the access history information for a prescribed number of accesses on the basis of the access history information that corresponds to the access time. An example of the interpolation process unit 13 is an interpolation process unit 29, which will be explained later.

As described above, increasing the accuracy of pieces of memory access history information collected for every prescribed number of memory accesses can be achieved.

Then the access time is shorter than the threshold, the interpolation process unit 13 adds, on the basis of the access history information corresponding to the access time, at least one piece of access history information to the position immediately previous to that access history information.

Accordingly, when the access time is shorter than the threshold, i.e., when the access is treated as continuous accesses, pieces of access history information intermitted between pieces of access history information can be interpolated.

When the access time is shorter than the threshold, the interpolation process unit 13 sets a prescribed size as the size of the data included in the access history information that corresponds to the access time.

Accordingly, when the access time is shorter than the threshold, i.e., when the access is treated as continuous accesses, it is possible to change the size of the accessed data included in the access history information corresponding to the access time as if continuous accesses had occurred.

When the access time is shorter than the threshold, the interpolation process unit 13 provides, to the access history information corresponding to the access time, identification information for identifying that the information is an interpolation target.

Accordingly, when the access time is shorter than the threshold, i.e., when the access is treated as continuous accesses, a flag is added to a continuous-access portion. This makes it possible to interpolate access history information by using the flag for analysis to be conducted later.

Hereinafter, the present embodiment will be explained in detail.

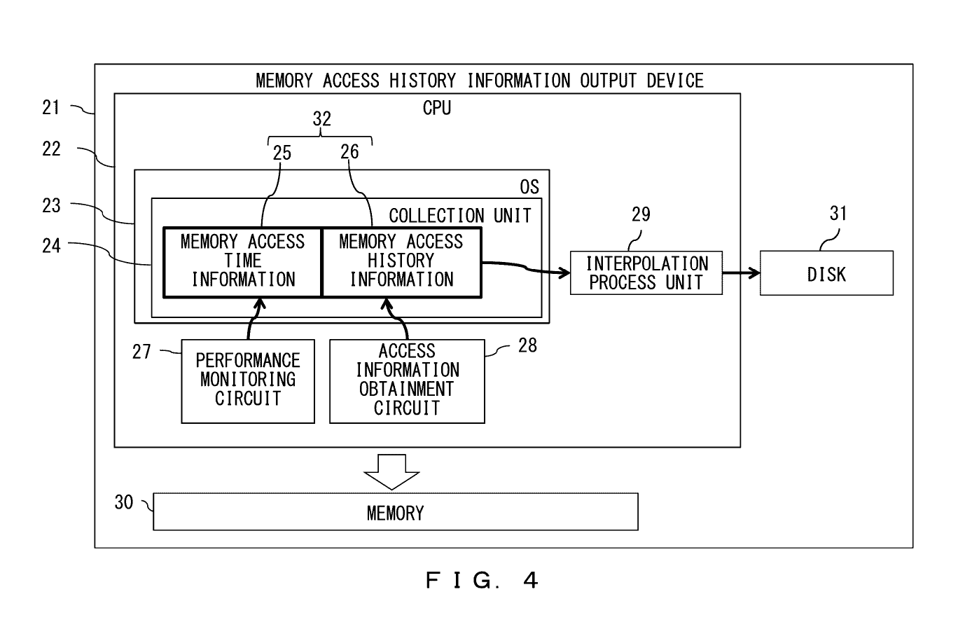

FIG. 4 illustrates an example of memory access history information output device according to the present embodiment. A memory access history information output device 21 is an information processing device that outputs memory access history information.

The memory access history information output device 21 includes a CPU 22, a memory 30 and a disk 31. The CPU 22 is an arithmetic device that controls the entire operations of the memory access history information output device 21. The memory 30 is a storage device that temporarily stores information, and is for example a DIMM. The disk 31 is a storage unit that stores a large amount of information at a speed lower than that of the memory 30, and is for example a hard disk drive.

The CPU 22 includes a performance monitoring circuit 27 and an access information obtainment circuit 28. In the case of a CPU manufactured by Intel Corporation for example, a Load Latency Performance Monitoring Facility (LLPMF) is used as the performance monitoring circuit 27 and a performance counter is used as the access information obtainment circuit 28. In such a case, as will be explained later, an LLPMF and a performance counter are set in advance for collecting pieces of memory access history information.

The performance monitoring circuit 27 calculates a period of time (memory access time) between when the CPU 22 issues an access request to the memory and when the memory 30 receives the response to it. The performance monitoring circuit 27 feeds to memory access time information (memory access time information) 25 on the calculated memory access time. For example, by using the LLPMF so as to perform setting so that the memory access time is obtained for a load instruction for each data collection from the memory 30, the LLPMF is made to function as the performance monitoring circuit 27.

When pieces of memory access history information are to be obtained for every prescribed number of memory accesses, the memory access time calculated by the performance monitoring circuit 27 may be an average memory access time for a prescribed number of memory accesses or may be a memory access time of a case when an access was made to the memory. In the present embodiment, explanations are given by using an average memory access time as a memory access time.

Note that an LLPMF is used for the performance monitoring circuit 27 in the present embodiment, but the present embodiment is not limited to this, and for example a program including all the above functions of the performance monitoring circuit 27 may be used. In such a case, the program including the functions of the performance monitoring circuit 27 may be part of an Operating System (OS) 23 or may be a program independent from the OS 23.

The access information obtainment circuit 28 obtains memory access history information, such as the instruction addresses, the data addresses, and the data size for every prescribed number of accesses, that is used for tracing memory accesses. The access information obtainment circuit 28 feeds obtained memory access history information 26 to a collection unit 24. The performance counter is made to function as the access information obtainment circuit 28 by for example setting the performance counter in such a manner that pieces of the memory access history information 26 are obtained for every prescribed number of load instructions.

Note that a performance counter is used for the access information obtainment circuit 28 in the present embodiment, the present embodiment is not limited to this example, and for example a program including all the above functions of the access information obtainment circuit 28 may be used. In such a case, the program including the functions of the access information obtainment circuit 28 may be part of the OS 23 or may be a program independent from the OS 23.

The OS 23 and a program that functions as the interpolation process unit 29 operates on the CPU 22. The OS 23 is operating software that manages the entire system. The OS 23 includes the collection unit 24.

The collection unit 24 collects from the performance monitoring circuit 27 the average memory access times calculated by the performance monitoring circuit 27 so as to accumulate them in response to memory accesses made during the operation of the OS 23.

Also, the collection unit 24 collects from the access information obtainment circuit 28 pieces of memory access history information obtained by the access information obtainment circuit 28 for every prescribed number of memory accesses and accumulates them, in response to memory accesses made during the operation of the OS 23. In this process, the collection unit 24 accumulates, as memory access history relationship information 32, the average memory access time and the memory access history information obtained at the timing of an access in an associated state.

Note that while the collection unit 24 is included in the OS 23 in the present embodiment, the present embodiment is not limited to this, and the collection unit 24 may be a program independent from the OS 23.

The interpolation process unit 29 obtains the memory access history relationship information 32 from the collection unit 24. On the basis of the memory access time included in the memory access history relationship information 32, the interpolation process unit 29 determines whether that memory access history relationship information 32 is memory access history information that is receiving continuous accesses. Determining the information to be memory access history information that is receiving continuous accesses, the interpolation process unit 29 interpolates pieces of memory access history information obtained intermittently, or processes the information into a format that allows the interpolation. The interpolation process unit 29 outputs the interpolated memory access history information to the disk 31.

Interpolation of memory access history information refers to a process including generating of pieces of memory access history information that are estimated to have been intermitted for a prescribed number of bytes counting from the memory access history information determined to be receiving continuous accesses and adding of the generated pieces of data to the existing memory access history information. In the explanations below, pieces of memory access history information estimated to have been intermitted may also be referred to as pieces of estimated memory access history information.

Processing memory access history information into a format that allows interpolation refers to a process including adding of a prescribed flag to memory access history information determined to be receiving continuous accesses or changing of the data size of such memory access history information to a prescribed size.

In this example, when a prescribed flag has been added to memory access history information, it is possible to determine that the information is memory access history information that received continuous accesses or to perform the above interpolation on the basis of that prescribed flag. Also, when the data size of memory access history information has been changed to a prescribed size, it possible to determine that the information received continuous accesses for that prescribed size.

Note that a program functioning as the interpolation process unit 29 may be a module in the OS 23 or may be an application program operating on the OS 23. Also, the interpolation process unit 29 may include a program that functions as the collection unit 24. Further, the interpolation process unit 29 may include a program including the above functions of the performance monitoring circuit 27 and a program including the above functions of the access information obtainment circuit 28.

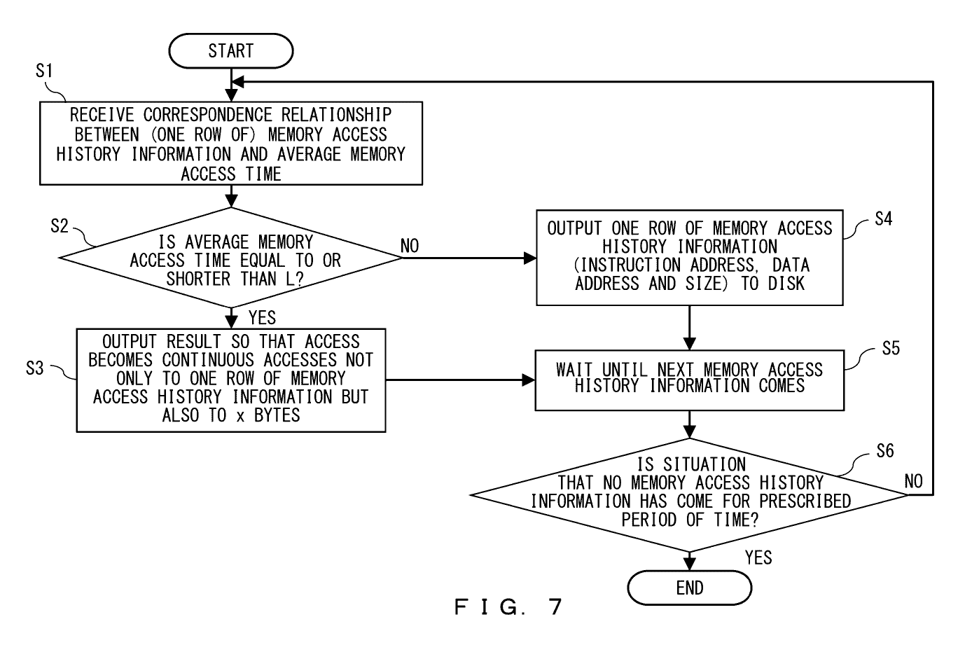

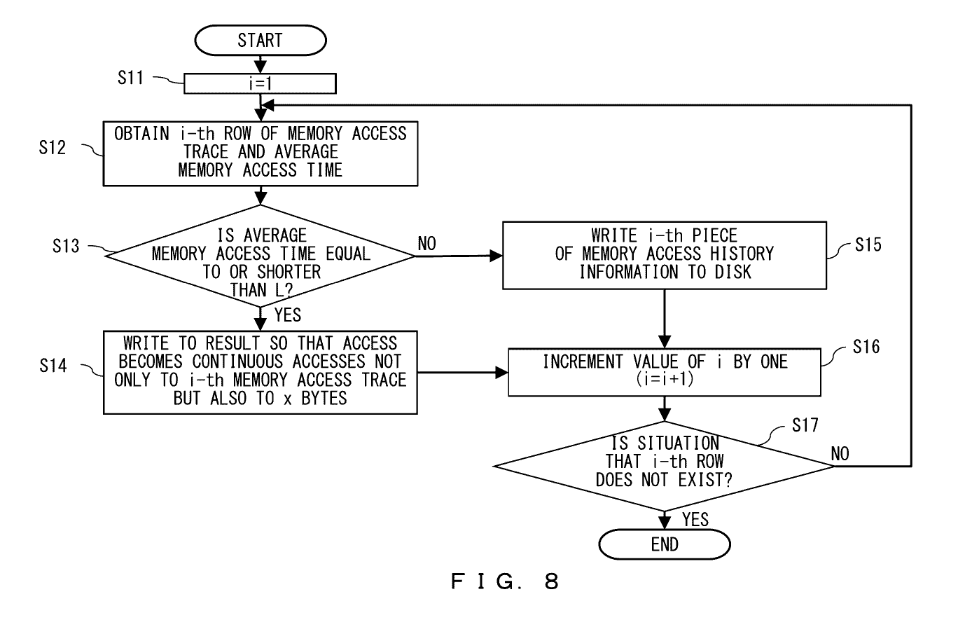

Also, as exemplified by FIG. 7, the interpolation process unit 29 may be included in an execution information recording program that records the execution information. Also, as exemplified by FIG. 8, the interpolation process unit 29 may be included in a memory information analysis program that analyzes information regarding memory accesses.

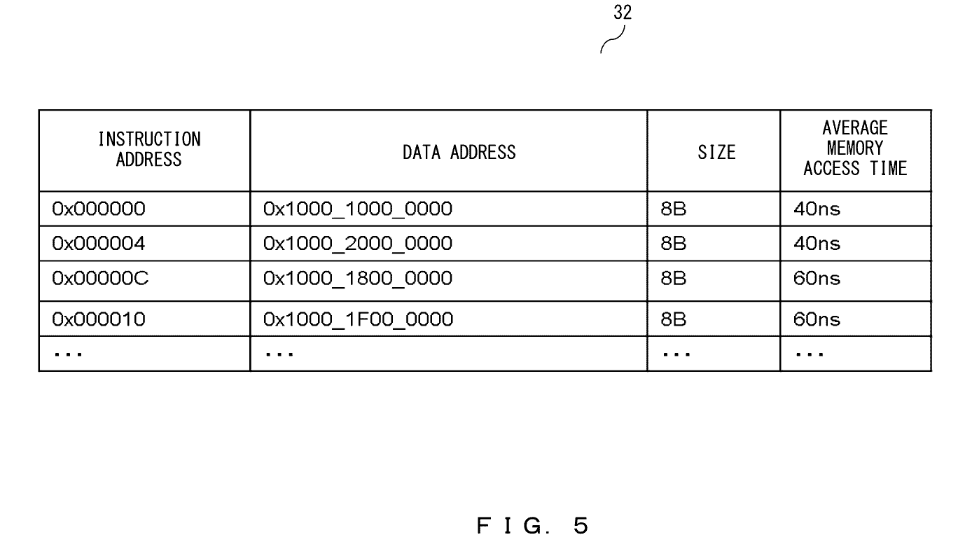

FIG. 5 exemplifies memory access history relationship information according to the present embodiment. As an example, the interpolation process unit 29 obtains the memory access history relationship information 32 exemplified in FIG. 5 as input information.

In the memory access history relationship information 32, pieces of information in which the memory access history information 26 and the average memory access time information 25 are associated are registered in time sequence (in the order of memory access). Specifically, the memory access history relationship information 32 includes items for “instruction address”, “data address”, “size” and “average memory access time”. Item for “instruction address” stores the address on the memory 30 at which the instruction to execute next is stored. Item for “data address” stores the address of data that is processed by an instruction stored in item for “instruction address”. Item for “size” stores the size of data that is stored in item for “data address”.

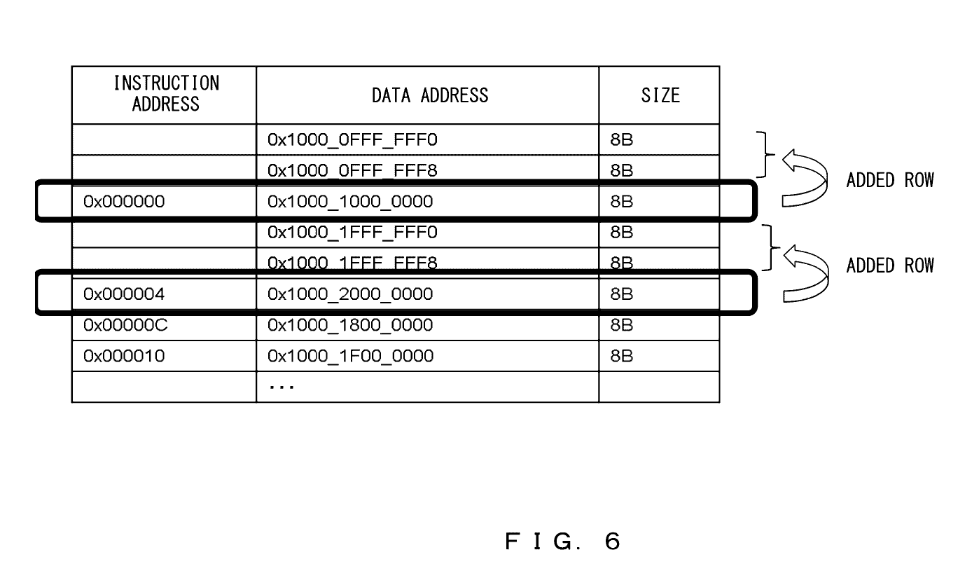

FIG. 6 illustrates an example of an output of interpolated memory access history information according to the present embodiment. Pieces of Memory access history information are output in time sequence (in the order of memory access). In FIG. 6, when the average memory access time is shorter than the threshold, the interpolation process unit 29 has added, as interpolation, pieces of memory access history information to intermitted portions of the memory access history information 26 illustrated in FIG. 5. Specifically, the interpolation process unit 29 adds a prescribed number of rows of pieces of past memory access history information to the position previous to rows that are considered by the interpolation process unit 29 to have an average memory access time equal to or longer than the threshold, i.e., that are considered by the interpolation process unit 29 to be receiving continuous accesses.

In the example illustrated in FIG. 6, the interpolation process unit 29 treats target rows with the average memory access time of 40 [ns], which is smaller than the threshold, as continuous accesses, and adds two rows of past memory access history information as interpolation information to the position previous to the target row.

FIG. 7 illustrates an interpolation process flow for memory access history information in the present embodiment (example 1). The flow illustrated in FIG. 7 is for performing an interpolation process of memory access history information on an as-needed basis during the obtainment of the memory access history information and the average memory access time. In such a case, the interpolation process unit 29 conducts the following operations during the collection of pieces of memory access history relationship information as part of the execution information recording program.

The interpolation process unit 29 receives a row of the memory access history relationship information 32 (memory access history information and average memory access time) from the collection unit 24 (S1).

The interpolation process unit 29 determines whether the received average memory access time is equal to or shorter than threshold L (S2). In this example, threshold L is a prescribed value (real number).

When the average memory access time is equal to or shorter than threshold L (Yes in S2), the interpolation process unit 29 outputs that result to the disk 31 so that the access becomes continuous accesses not only to one row of memory access history information but also to a prescribed number of bytes (x bytes) (S3). In this example, the interpolation process unit 29 generates y rows of estimated memory access history information so that the access becomes continuous accesses for a prescribed number of bytes counted counting from the received memory access history relationship information (generation-source memory access history relationship information). In the above, y={x/(data size z included in generation-source memory access history relationship information)−1} is satisfied. Each piece of estimated memory access history information includes data size z (bytes) and a data address obtained by sequentially subtracting z (bytes) from the data addresses of the generation-source memory access history relationship information. Note that the instruction address becomes vacant. The interpolation process unit 29 outputs a result of adding, to the generation-source memory access history information, generated y rows of estimated memory access history information.

For example, when it is determined that the data size is 8 bytes, x=24 (bytes) and continuous accesses occurred, the result is output so that three continuous accesses occur. As illustrated in FIG. 6, it is assumed for example that the data address included in the received first row of the memory access history relationship information is 0x1000_1000_0000 (in hexadecimal). When continuous accesses is determined to have occurred, the data size used in the memory access identified by that one row of the memory access history relationship information is 8 (bytes), and accordingly it is estimated that two memory accesses occurred to continuous data addresses immediately previous to this memory access. Thus, the interpolation process unit 29 adds, to that one row of the memory access history information, past two rows of memory access history information obtained by shifting the data address by 8 bytes. In this example, the two rows of the memory access history information identified by the data addresses of “0x1000_0FFF_FFF8” and “0x1000_0FFF_FFF0” are added.

By the above process, the interpolation process unit 29 can output history information representing the fact that continuous accesses were made to pieces of data with the data addresses of 0x1000_0FFF_FFF0, 0x1000_0FFF_FFF8 and 0x1000_1000_0000.

When the average memory access time is longer than threshold L (No in S2), the interpolation process unit 29 outputs to the disk 31 the memory access history information (instruction address, data address and size) obtained in S1 (S4).

After the termination of the process in S3 or S4, the interpolation process unit 29 waits until the next memory access history information arrives from the collection unit 24 (S5). When the memory access history information has arrived within a prescribed period of time (No in S6), the process returns to the process in S1.

When the memory access history information does not arrive from the collection unit 24 within a prescribed period of time (Yes in S6), the process in this flowchart is terminated.

FIG. 8 illustrates an interpolation process flow of memory access history information in the present embodiment (example 2). The flow illustrated in FIG. 8 is for performing an interpolation process of the memory access history information after the obtainment of memory access history information and average memory access time. In such a case, the interpolation process unit 29 conducts the following operations after the obtainment of memory access history relationship information as part of the memory information analysis program.

The interpolation process unit 29 initializes counter variable i by “1” (S11).

The interpolation process unit 29 receives, from the collection unit 24, the i-th row of the memory access history relationship information 32 (the memory access history information and the average memory access time) (S12).

The interpolation process unit 29 determines whether the obtained average memory access time is equal to or shorter than threshold L (S13).

When the average memory access time is equal to or shorter than threshold L (Yes in S13), the interpolation process unit 29 outputs that result to the disk 31 so that the access becomes continuous accesses not only to the i-th row of memory access history information but also to a prescribed number of bytes (x bytes) (s14). The process in S14 is similar to the process in S3 illustrated in FIG. 7.

It is assumed as illustrated in FIG. 6 for example that the data size is 8 bytes, x=24 and the data address included in the i-th piece of the memory access history relationship information is “0x1000_1000_0000”. In such a case, the interpolation process unit 29 adds, to the i-th piece of the memory access history relationship information, past two rows of memory access history information obtained by shifting the data address by 8 bytes as explained in S3 in FIG. 7 (FIG. 6).

When the average memory access time corresponding to the obtained memory access history information is longer than threshold L (No in S13), the interpolation process unit 29 outputs the i-th row of the memory access history information (instruction address, data address and size) to the disk 31 (S15).

After the termination of the process in S14 or S15, the interpolation process unit 29 increments the value of i (s16).

When the i-th row exists in the memory access history relationship information 32 (No in S17), the interpolation process unit 29 performs the processes in and subsequent to S12.

When the i-th row exists in the memory access history relationship information 32 (Yes in S17), the process of this flowchart is terminated.

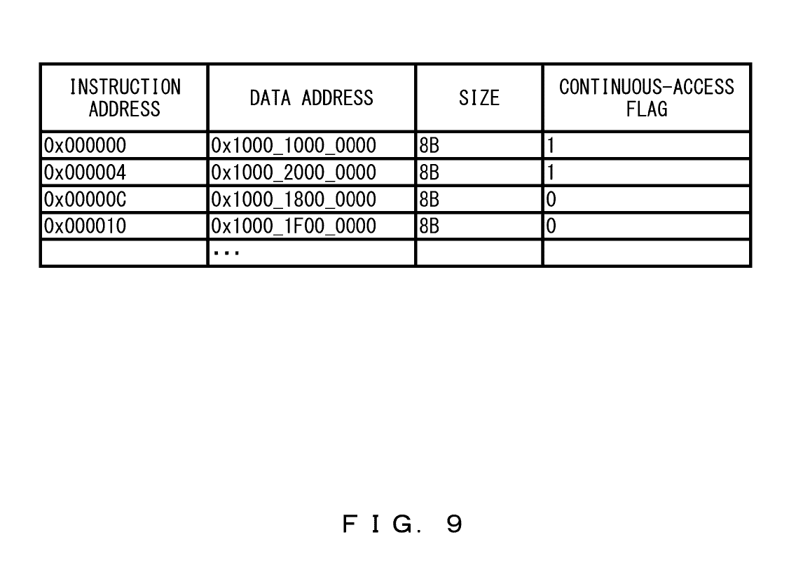

FIG. 9 illustrates another output example (variation example 1) of interpolated memory access history information according to the present embodiment. FIG. 9 illustrates an example in which when the average memory access time corresponding to the memory access history information is equal to or shorter than threshold L, specifically when the access has been determined to be continuous accesses, a flag indicating a continuous-access portion has been added.

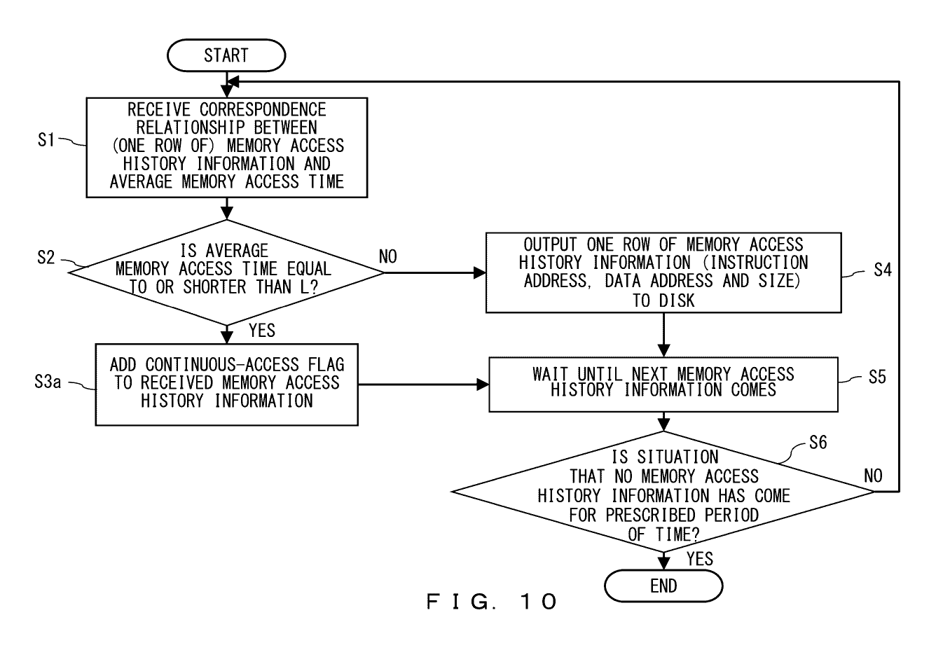

FIG. 10 illustrates an interpolation process flow of memory access history information according to the present embodiment (variation example 1). In the flow in FIG. 10, S3a is performed in place of S3 in the flow of FIG. 7.

When it is determined that the average memory access time is equal to or shorter than threshold L, specifically that the access is made to a continuous-access portion (Yes in S2), the interpolation process unit 29 adds a flag indicating a continuous-access portion (continuous accesses flag) to the received memory access history information (S3a).

Note that when an interpolation process is to be performed on memory access history information after the obtainment of the memory access history information and the average memory access time, S14 may be replaced by S3a in the flow illustrated in FIG. 8.

Thereby, on an arbitrary timing after that, the interpolation process unit 29 can generate estimated memory access history information (the process in S3 in FIG. 7 or S14 in FIG. 8) in accordance with the continuous-access flag.

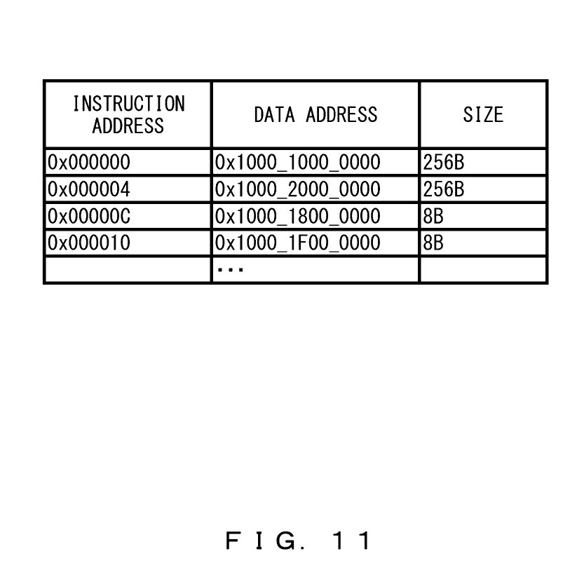

FIG. 11 illustrates another output example (variation example 2) of interpolated memory access history information according to the present embodiment. FIG. 11 illustrates a case in which it was determined that the average memory access time corresponding to the memory access history information was equal to or shorter than threshold L, or specifically that the access was made to a continuous-access portion and accordingly the size was changed as if continuous accesses had occurred.

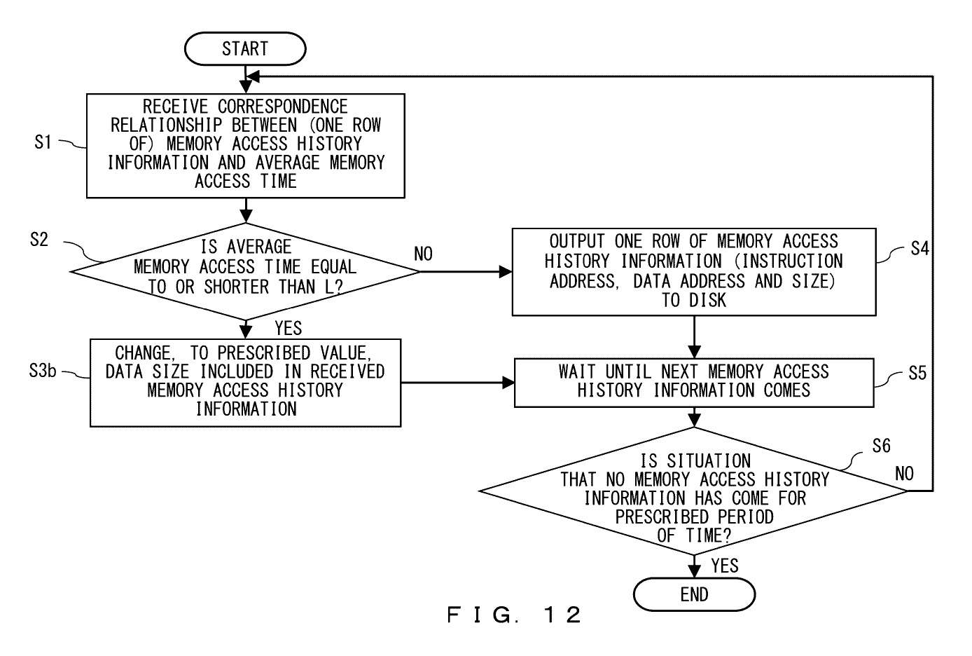

FIG. 12 illustrates an interpolation process flow of memory access history information in the present embodiment (variation example 2). In the flow in FIG. 12, S3b is performed in place of S3 in the flow of FIG. 8.

Determining that the average memory access time is equal to or shorter than threshold L, or specifically that the access is made to a continuous-access portion (Yes in S2), the interpolation process unit 29 changes the data size to prescribed value k (bytes) as if continuous accesses had occurred (S3b). In this example, prescribed value k is expressed by “data size included in the memory access history information×n (n is an integer).

In the case illustrated in FIG. 11, a comparison of the row of the instruction address of “0x000000” with the memory access history information before receiving the interpolation illustrated in FIG. 5 indicates that the data size has been changed from “8 bytes” to “256 bytes”. Thereby, it is possible to make the situation look as if data of 256 bytes had been accessed continuously. Note that the size to be changed is set to 256 bytes in this example, whereas the present embodiment is not limited to this example and an arbitrary value can be set as a parameter.

Note that when an interpolation process is to be performed on memory access history information after the obtainment of the memory access history information and the average memory access time, S14 may be replaced by S3b in the flow illustrated in FIG. 8.

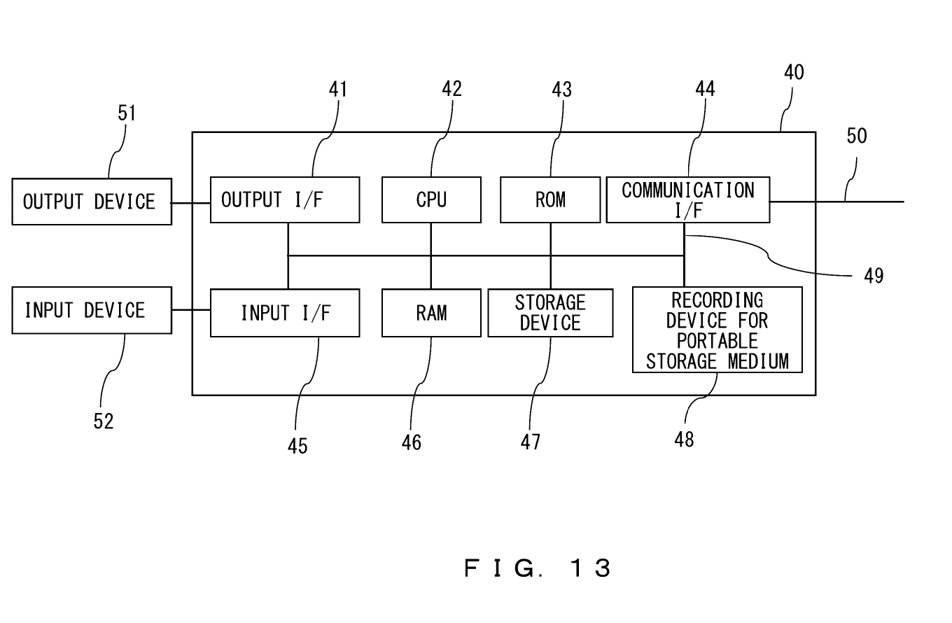

FIG. 13 illustrates an example of a configuration block of a hardware environment of a computer that executes a program according to the present embodiment. A computer 40 functions as the information process device 11 or the memory access history information output device 21. The computer 40 includes a CPU 42, a ROM 43, a RAM 46, a communication I/F 44, a storage device 47, an output I/F 41, an input I/F 45, a reading device 48, a bus 49, an output device 51 and an input device 52.

CPU used herein refers to a central processing unit. The CPU is an example of a processor. ROM refers to a read only memory. RAM refers to a random access memory. I/F refers to an interface. To bus 49, the CPU 42, the ROM 43, the RAM 46, the communication I/F 44, the storage device 47, the output I/F 41, the input I/F 45 and the reading device 48 are connected. The reading device 48 is a device for reading information from a portable recording medium. The output device 51 is connected to the output I/F 41. The input device 52 is connected to the input I/F 45.

For the storage device 47, a storage device in various forms including a hard disk, a flash memory, a magnetic disk, etc. can be used. The storage device 47 or the ROM 43 stores a program, according to the present embodiment, that makes the CPU 42 function as the obtainment unit 12 and the interpolation process unit 13. More specifically, the storage device 47 or the ROM 43 stores a program, according to the present embodiment, that makes the CPU 42 function as the collection unit 24 and the interpolation process unit 29. The storage device 47 or the ROM 43 may store a program corresponding to the performance monitoring circuit or a program corresponding to the access information obtainment circuit 28. The storage device 47 corresponds to the disk 31 according to the present embodiment.

The RAM 46 temporarily stores information. The RAM 46 corresponds to the memory 30 according to the present embodiment.

The CPU 42 reads from the storage device 47 or the ROM 43 a program according to the present embodiment so as to execute the program.

The communication I/F 44 is an interface such as a port etc. to be connected to a network in order to communicate with other devices.

A program that implements the processes explained in the above embodiment may be stored in for example the storage device 47 by the program provider side via a communication network 50 and a communication I/F 44. Also, a program that implements the processes explained in the above embodiment may be stored in a portable storage medium that is marketed and distributed. In such a case, the program may be implemented by being read by the CPU 42 from the portable storage medium set in the reading device 48. For the portable storage medium, a storage medium in a various form including a CD-ROM, a flexible disk, an optical disk, an magneto-optical disk, an IC card, an USB memory device, a semiconductor memory card, etc. can be used. The program stored in a storage medium as described above is read by the reading device 48.

For the input device 52, a keyboard, a mouse, an electron camera, a web camera, a microphone, a scanner, a sensor, a tablet, a touch panel, etc. can be used. For the output device 51, a display device, a printer, a speaker, etc. can be used.

Examples of the network 50 include the Internet, a Local Area Network (LAN), a Wide Area Network (WAN), a dedicated-line network, a wired network, a wireless network, etc.

The present embodiment makes it possible to obtain memory access history information with higher accuracy and in almost the same period of time as in a case when the second method described above is used to obtain pieces of memory access history information for every prescribed period of time. This leads to an increase in the accuracy of pieces of memory access history information collected for a prescribed number of memory accesses.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device comprising:
a processor that
obtains, for every prescribed number of accesses to the memory, access history information representing a history of an access to a memory and information of an access time taken to obtain information from the memory through the and
performs an interpolation process on access history information for the prescribed number of accesses on the basis of the access history information corresponding to the access time when the access time is shorter than a threshold.

2. The information processing device according to claim 1, wherein
the processor adds access history information to a position immediately previous to the access history information on the basis of the access history information corresponding to the access time when the access time is shorter than a threshold.

3. The information processing device according to claim 1, wherein
the processor sets a prescribed size as a size of accessed data included in the access history information corresponding to the access time when the access time is shorter than a threshold.

4. The information processing device according to claim 1, wherein
the processor adds, to the access history information corresponding to the access time, identification information for identifying that the information is an interpolation target when the access time is shorter than a threshold.

5. A non-transitory computer-readable recoding medium having stored therein an access information management program for causing a computer to execute a process comprising:
obtaining, for every prescribed number of accesses to the memory, access history information representing a history of an access to a memory and information of an access time taken to obtain information from the memory through the access; and
performing an interpolation process on access history information for the prescribed number of accesses on the basis of the access history information corresponding to the access time when the access time is shorter than a threshold.

6. An access information management method conducted by a processor, the access information management method comprising:
obtaining, for every prescribed number of accesses to the memory, access history information representing a history of an access to a memory and information of an access time taken to obtain information from the memory through the access; and
performing an interpolation process on access history information for the prescribed number of accesses on the basis of the access history information corresponding to the access time when the access time is shorter than a threshold.
